(19) United States
(12) Patent Application Publication
(10) Pub. No.: US 2025/0346164 A1
(43) Pub. Date: Nov. 13, 2025

(54) SEAT ASSEMBLY AND FASTENING ARRANGEMENT

(71) Applicant: Lear Corporation, Southfield, MI (US)

(72) Inventors: Mark Karges, Macomb, MI (US); Carlo Suson Pestano, Mandaue City (PH); Fernando Reyes, Cebu City (PH); Vinissa Baya, Cebu City (PH); Derek Basco, Cebu City (PH); Earl Andrei Ornopia, Mandaue City (PH); Michael Kint Alope, Cebu City (PH)

(73) Assignee: Lear Corporation, Southfield, MI (US)

(21) Appl. No.: 18/662,169

(22) Filed: May 13, 2024

(51) Int. Cl. B60N 2/58; A47C 7/24

(52) U.S. Cl. CPC B60N 2/5825; A47C 7/24

(57) ABSTRACT

A seat assembly and a fastening arrangement. The fastening arrangement comprises a base and a fastener that extends from the base. The fastener is configured to extend into a cushion that comprises a mesh member that includes a set of filaments. The fastener engages at least one member of the set of filaments, coupling the fastening arrangement to the cushion.

### TECHNICAL FIELD

This relates to a seat assembly and a fastening arrangement.

### BRIEF DESCRIPTION OF THE DRAWINGS

FIG. 1 is a perspective view of an example of a seat assembly including a filament mesh structure.

FIG. 2 is schematic view of an example of a manufacturing system for making the filament mesh structure.

FIG. 3 is a magnified view of an example of the filament mesh structure.

FIG. 4 is a perspective view of an example of a fastening arrangement.

FIG. 5 is a plan view of the fastening arrangement of FIG. 4.

FIG. 6 is a magnified perspective view of a portion of the fastening arrangement of FIG. 4.

FIG. 7 is a side view showing a portion of the fastening arrangement of FIG. 4 securing the filament mesh structure to a substrate, such as a frame of the seat assembly.

FIGS. 8 and 9 are perspective views of another example of a fastening arrangement.

FIG. 10 a plan view of the fastening arrangement of FIG. 8.

FIG. 11 is a bottom view of the fastening arrangement of FIG. 8.

FIG. 12 is a side view showing a portion of the fastening arrangement of FIG. 8 securing two filament mesh structures to each other.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

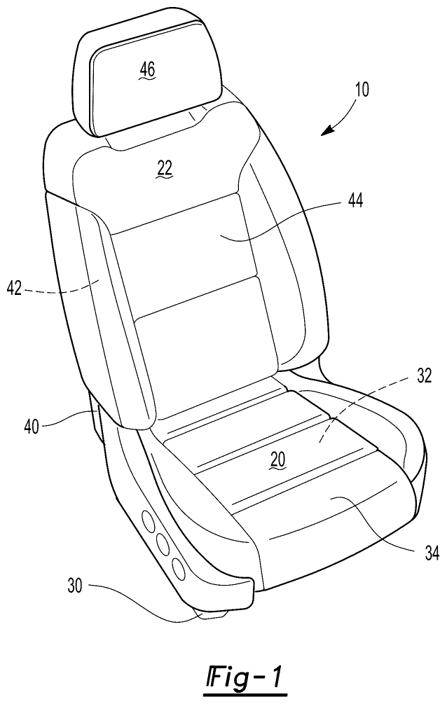

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad as will be discussed in more detail below.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 3, a magnified view of an example of a cushion 50 is shown. The cushion is generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 3, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. An example of filaments 52 is best shown in FIG. 3. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

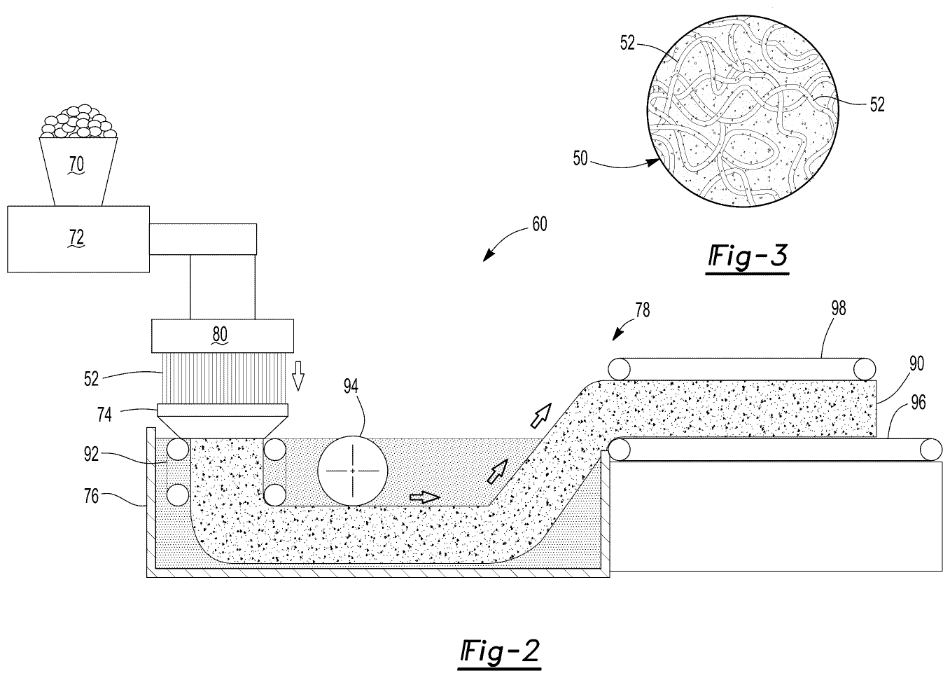

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 of making a cushion or filament mesh structure is also shown in FIG. 2. In this example, the manufacturing system 60 includes a material supply 70, an extruder 72, and a funnel 74. The manufacturing system 60 also includes a cooling tank 76 and a material handling subsystem 78.

Referring to FIG. 2, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and a filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments may slide along the funnel 74 or an intervening sheet that is disposed on the funnel 74 as the filaments move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a mesh member or filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting system of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

With the above process, the cushion 50 may be formed of a set of filaments 52, wherein at least two members of the set of filaments 52 are looped and bonded to each other. In one or more embodiments, each member of the set of filaments 52 is looped and bonded to at least one other member of the set of filaments 52.

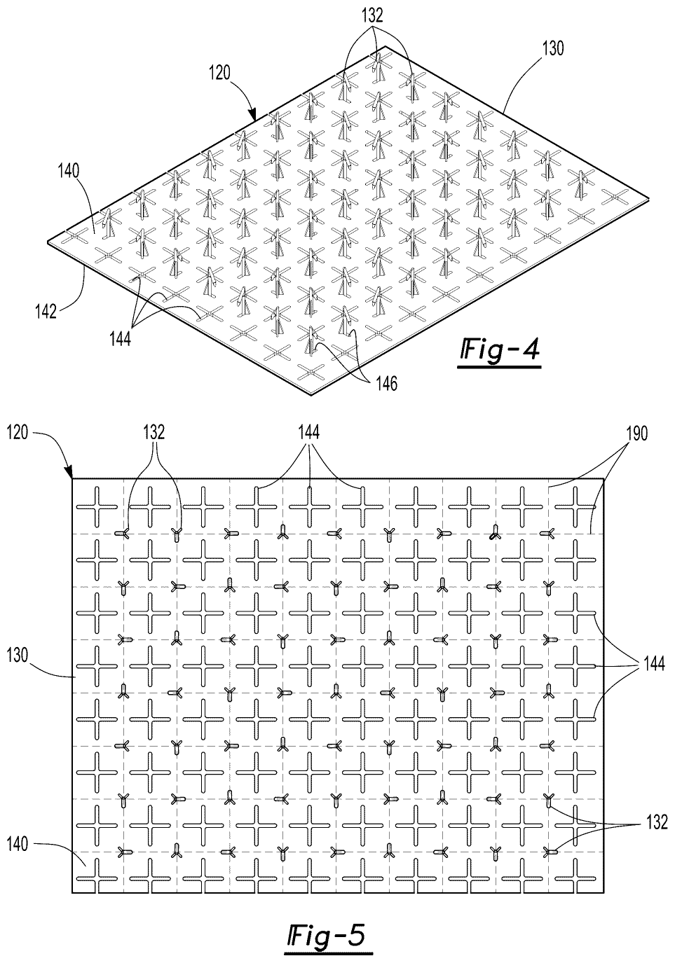

Referring to FIGS. 4-12, examples of fastening arrangements will now be discussed. For convenience in reference, the frame, which may also be referred to as a substrate, is generically designated with reference number 100. It is to be understood that the frame 100 may be the seat bottom frame 30 or the seat back frame 40. In some configurations, the seat bottom frame 30 or the seat back frame 40 may include an armrest. The trim cover is generically designated with reference number 110. It is to be understood that the trim cover 110 may be the trim cover 34 of the seat bottom 20 or the trim cover 44 of the seat back 22.

As an overview, a cushion 50 that comprises a mesh member or filament mesh structure 90 may move or slide with respect to the frame 100 when the cushion 50 is not secured to the frame 100. For instance, the cushion 50 may move or slide with respect to the frame 100 when the trim cover 110 is pulled over or installed over the cushion 50 and the frame 100. Similarly, intervening components disposed between the cushion 50 and the trim cover 110, such as a heating pad, may also be displaced from a desired location on the cushion 50. As a result, components such as the trim cover 110, the heating pad, and the like may be difficult to install or require additional time to install when the cushion 50 is not secured to the frame 100.

In some configurations, a cushion 50 may comprise a plurality of mesh members or pieces of the filament mesh structure 90. For instance, one mesh member may be stacked on i or disposed adjacent to another mesh member to build a cushion 50 from multiple mesh members. One mesh member may move or slide with respect to another mesh member when a mesh member is not secured to another mesh member. As a result, pieces of the cushion 50 are susceptible to displacement with respect to each other when handled or when another component such as a trim cover is installed over the cushion 50.

To address these issues, the present invention employs one or more fastening arrangements. In some configurations, a fastening arrangement couples (e.g., attaches, fastens, secures) the cushion 50 to the frame 100. In some configurations, a fastening arrangement couples one mesh member to another mesh member. It is contemplated that multiple configurations of fastening arrangements may be employed with a cushion 50. For instance, one or more fastening arrangements may couple different mesh members or different pieces of the filament mesh structure 90 to each other, thereby assembling the cushion 50 or a portion thereof, while one or more fastening arrangements may couple the cushion 50 to the frame 100. For convenience in reference, a fastening arrangement that is configured to couple the cushion 50 to the frame 100 is designated with reference number 120 while a fastening arrangement that is configured to couple one mesh member to another mesh member is designated with reference number 120′.

The fastening arrangement 120, 120′ may be made of any suitable material, such as a polymeric material, metal, or combinations thereof. The fastening arrangement 120, 120′ may be manufactured using any suitable process, such as by molding, additive manufacturing (e.g., 3D printing), subtractive manufacturing, or combinations thereof.

Referring to FIGS. 4-7, an example of a fastening arrangement 120 is shown. The fastening arrangement 120 comprises a base 130 and one or more fasteners 132. The fastening arrangement 120 may be manufactured as a unitary one-piece component in which the base 130 and fastener 132 are integrally formed.

The base 130 (e.g., footing, anchor, panel, platform, substrate) supports the fastener 132. In some configurations, the base 130 includes a first base side 140, a second base side 142, one or more openings 144, and one or more through holes 146.

Referring primarily to FIG. 7, the first base side 140 is configured to face toward the cushion 50. The cushion 50 is disposed on the base 130. For instance, a first side 150 of the cushion 50 may face toward and may be disposed on the first base side 140 while a second side 152 of the cushion 50 that is disposed opposite the first side 150 of the cushion 50 may be spaced apart from the base 130 and the first base side 140. One or more fasteners 132 extend from the first base side 140. The first base side 140 is illustrated as having a flat or planar configuration; however, it is contemplated that the first base side 140 may be nonplanar or may bend or flex to follow the contour of another component.

The second base side 142 is disposed opposite the first base side 140. As such, the second base side 142 may face away from the first side 150 of the cushion 50. In some configurations, the second base side 142 is disposed substantially parallel to the first base side 140. The second base side 142 is illustrated as having a flat or planar configuration; however, it is contemplated that the second base side 142 may be nonplanar or may bend or flex to follow the contour of another component. In the configuration shown in FIGS. 4-7, a fastener 132 of the fastening arrangement 120 does not extend from the second base side 142.

Referring to FIG. 7, in some configurations the base 130 is disposed on the frame 100. For instance, the second base side 142 may engage or contact the frame 100, such as a side of the frame that faces toward the base 130 and the cushion 50. The base 130 may be fastened or secured to the frame 100 in any suitable manner, such as with an adhesive, weld, or fastener like a threaded fastener, rivet, pin, hook, clip, clamp, or the like. As such, the base 130 may be inhibited from moving with respect to the frame 100.

Referring primarily to FIGS. 4 and 5, one or more openings 144 may be provided with the base 130. For clarity, only some of the openings are labeled in these figures. An opening 144 may be a member of a set of openings that are arranged in the base 130. An opening 144 may reduce the amount of material in the base 130, thereby reducing the weight of the fastening arrangement 120. An opening 144 may also make the base 130 easier to bend or flex so as to follow the contour of another component, such as the frame 100. An opening 144 (e.g., aperture, cavity, crevice, cut, gap, groove, hole, incision, perforation, slit, window) may have any suitable configuration.

In some configurations, an opening 144 extends through the base 130 from the first base side 140 to the second base side 142. In some configurations, an opening 144 extends partially through the base 130 from the first base side 140 toward the second base side 142 or from the second base side 142 toward the first base side 140. A set of openings may include openings 144 that extend through the base 130, extend partially through the base 130, or combinations thereof. In some configurations, an opening 144 is spaced apart from a fastener 132, which may help the base 130 bend or flex in regions located between fasteners 132.

Referring primarily to FIG. 5, an example of a set of openings 144 is shown. The openings 144 are depicted as extending through the base 130 and are arranged such that the openings 144 are spaced apart from each other. In some configurations, the openings 144 are arranged in a grid or grid pattern (e.g., network of lines that cross each other to form a series of quadrilaterals, such as squares or rectangles). For instance, openings 144 may be arranged in rows and columns that are disposed substantially perpendicular to each other. An opening 144 may be provided where a row and a column intersect. Rows of the grid, columns of the grid, or both may be offset from a fastener 132 such that a row of the grid, column of the grid, or both, do not intersect a fastener 132.

Openings 144 may be provided with various shapes or configurations. In some configurations, an opening 144 may be centered where a row and column intersect. In some configurations, an opening 144 is symmetrical or extends equidistantly from where a row and column intersect. For instance, an opening 144 may be provided with a circular configuration, polygonal configuration, or other symmetrical configuration. In the configuration shown in FIG. 5, an opening 144 has a plus sign (+) configuration with two intersecting slits. The slits are arranged such that a first slit extends in a first direction, such as along a row of the grid pattern, and a second slit extends in a second direction, such as along a column of the grid pattern. Such a configuration may allow the base 130 to bend or flex along a row, a column, or both to follow the contour of another component, such as the frame 100.

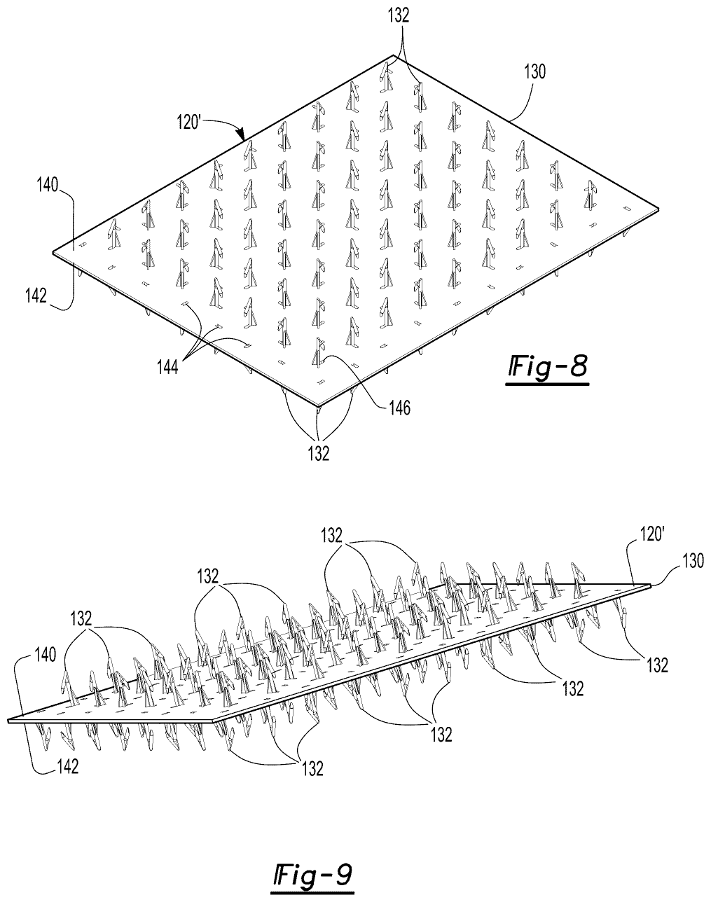

In other configurations, an opening 144 may not centered where a row and column intersect. An example of such a configuration is shown in FIG. 8. In FIG. 8, an opening has an elongated configuration in which an opening 144 extends farther in at least one direction from where a row and column intersect, such as along a row or column. Openings 144 in a row or column may extend in the same direction or different directions from where a row and column intersect. In FIG. 8, the openings 144 are arranged such that openings in a row alternate between extending along a row or column. For example, in the top row, the leftmost opening extends along a row (to the right), the next opening extends along a column (toward the bottom), the next opening extends along the row to the left), and so on. It is noted that openings as shown in FIG. 8 may be provided with the configuration shown in FIG. 4 and vice versa.

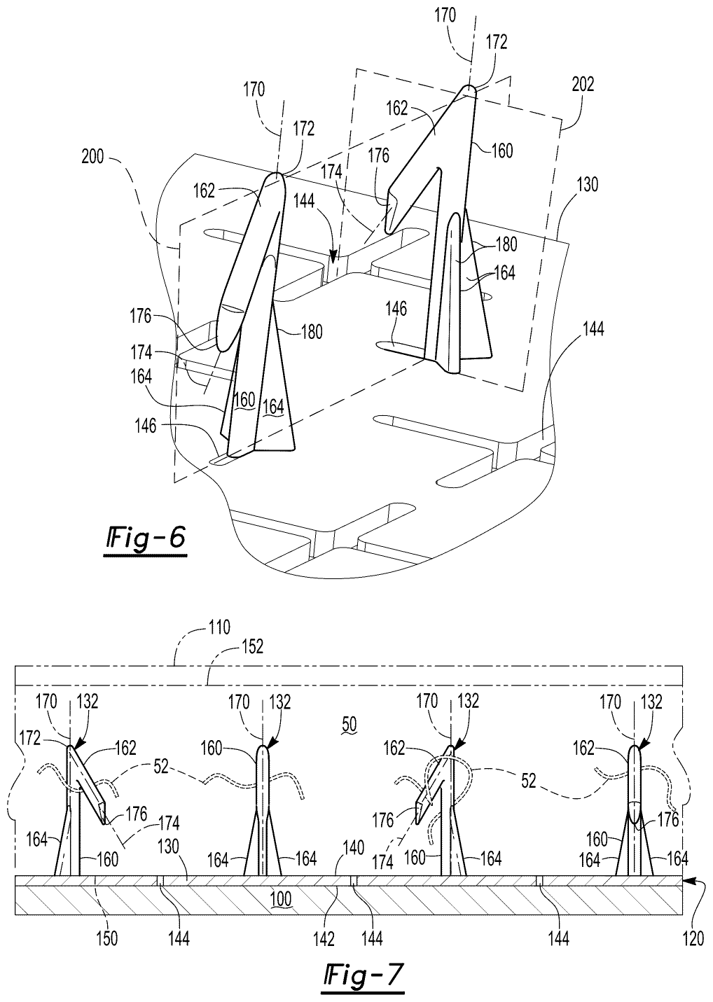

Referring primarily to FIG. 6, one or more through holes 146 may be provided with the base 130. The through hole 146 extends from the first base side 140 to the second base side 142. In some configurations, a through hole 146 is spaced apart from and does not extend from an opening 144. The through hole 146 may be disposed adjacent to (e.g., next to, extend from, abut, neighbor) the fastener 132 of the fastening arrangement 120. The through hole 146 may be aligned with a barb of the fastener 132 to allow a support feature, such as a wall or protrusion, to extend through the through hole 146 and protrude from the first base side 140 and support the barb during manufacturing of the fastener 132. It is also contemplated that the through hole 146 may help reduce the weight of the base 130 and may help improve the flexibility of the base 130.

One or more fasteners 132 (e.g., attachment feature, coupling, clamp, hook) extend from the base 130. For clarity, only some of the fasteners 132 are labeled in FIGS. 4, 5, and 8-11. Fasteners 132 are depicted with a common configuration in FIGS. 4-12. In the configuration shown in FIGS. 4-7, fasteners 132 extend from one side of the base 130, such as the first base side 140. In the configuration shown in FIGS. 8-12, fasteners 132 extend from multiple sides of the base 130, such as from the first base side 140 and the second base side 142.

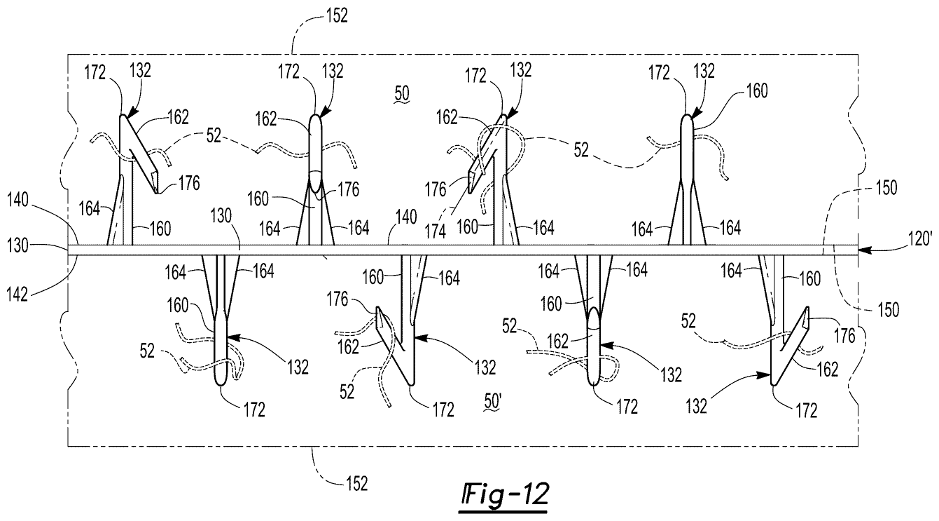

The fastener 132 couples the fastening arrangement 120, 120′ to a cushion 50. In some configurations, the fastener 132 extends from the base 130 into a cushion 50 and engages (e.g., captures, catches, grasps, holds, seizes, snags) at least one member of the set of filaments 52 of the mesh member or filament mesh structure of the cushion 50, thereby coupling (e.g., connecting, securing, joining, tethering, attaching, tying, binding, fastening, affixing, linking) the fastening arrangement 120, 120 to the cushion 50. Examples of fasteners 132 engaging filaments 52 are shown in FIGS. 7 and 12. In these figures, only fragmentary portions of filaments 52 are shown for clarity. In FIG. 7, a single cushion 50 and filaments 52 are shown in phantom. In FIG. 12, two cushions 50, 50 and corresponding filaments 52 are shown in phantom.

In some configurations, the fastening arrangement 120, 120′ or fastener 132 of a fastening arrangement 120, 120′ is spaced apart from and may not extend to the trim cover 110. An example of this is shown in FIG. 7. In FIG. 7, the trim cover 110 is shown in phantom on the second side 152 of the cushion 50 with a portion of the filament mesh structure of the cushion 50 extending between the trim cover 110 and the fastener 132. The fastener 132 extends from the base 130 into the cushion 50 through the first side 150 of the cushion 50 and extends toward the second side of the cushion 50. As such, the trim cover 110 is detached (e.g., disconnected, decoupled, separated, not attached, coupled, or secured to) from the fastening arrangement 120, 120′ or fastener 132.

Referring primarily to FIGS. 6 and 7, an example of a fastener 132 is shown. In some configurations, the fastener 132 comprises a shaft 160, a barb 162, and one or more ribs 164.

The shaft 160 extends from the base 130. In the configuration shown in FIGS. 4-7, the shaft 160 is depicted as extending from the first base side 140. In the configuration shown in FIGS. 8-12, at least one fastener 132 and a corresponding shaft 160 extends from the second base side 142. The shaft 160 (e.g., rod, tube, pole, shank, stem) may be solid or hollow. As is best shown in FIG. 7, a shaft 160 may extend from the base 130 along a shaft axis 170. In some configurations, the shaft axis 170 is disposed substantially perpendicular a side of the base 130 from which the shaft 160 extends, such as from the first base side 140 or a region of the first base side 140 that is disposed adjacent to the shaft 160. As is best shown in FIG. 6, in some configurations, the shaft 160 may be disposed adjacent to a through hole 146 in the base 130.

The barb 162 (e.g., hook, prong, projection, spur, tine, spike) extends from the shaft 160. In some configurations, the barb 162 extends from the shaft 160 toward the base 130. In the configuration shown in FIGS. 4-7, the barb 162 extends from the shaft 160 toward the first base side 140. In the configuration shown in FIGS. 8-12, the barb 162 of a fastener 132 that extends from the first base side 140 extends from the shaft 160 toward the first base side 140 and the barb of a fastener 132 that extends from the second base side 142 extends from a corresponding shaft toward the second base side 142.

In some configurations, the barb 162 extends along a barb axis 174 from a distal end 172 (e.g., end of the shaft 160 situated away from the point of attachment to the base 130) of the shaft 160 and is separated from (e.g., spaced apart from, disconnected from, does not extend to) the base 130. The barb 162 is separated from or spaced apart from the base 130 to allow one or more filaments 52 to be captured by the barb 162, such as being captured between the barb 162 and the base 130, between the barb 162 and the shaft 160, or both. In some configurations, the barb axis 174 is a linear axis that extends at an oblique angle toward the base 130 to allow the barb 162 and shaft 160 to act as a wedge to help the fastener 132 penetrate the cushion 50 or penetrate between filaments 52 of the mesh member of the cushion 50 when the fastener 132 is inserted into the cushion 50. As such, the shaft 160 and barb 162 may cooperate to push a filament 52 around the barb 162 during insertion and a filament 52 may be captured or hooked underneath the barb 162 when the filament 52 passes around a distal end 176 of the barb 162. In some configurations, the barb 162 is aligned with (e.g., in line with, coplanar with) a through hole 146 in the base 130, an example of which is best shown in FIG. 6. In some configurations, the through hole 146 and the barb 162 may extend substantially the same distance from the shaft 160.

One or more ribs 164 extend from the base 130 to the shaft 160. A rib 164 (e.g., brace, buttress, elongated ridge, fin, protrusion, reinforcement, stiffener, support) may help reinforce the shaft 160 to limit deflection of the shaft 160 and to help prevent the shaft 160 from breaking or cracking. In the configuration shown, two ribs 164 extend from the shaft 160; however, it is contemplated that a greater or lesser number of ribs 164 may be provided. In some configurations, the ribs 164 extend away from each other at an included angle of 180 degrees or less.

In some configurations, the barb 162 and the rib 164 extend away from the shaft 160 or shaft axis 170 in different directions, such as different angles or rotational positions when viewed along the shaft axis 170. For instance, a rib 164 may not extend in the same direction from the shaft axis 170 as the barb 162 and thus may not be disposed directly underneath the barb 162, such as where a through hole 146 is provided in the base 130. Providing one or more ribs 164 that extend away from the barb 162, the through hole 146, or both, may help reinforce the shaft 160 or resist bending of the shaft 160 in one or more directions that extend away from the barb 162. Providing a rib 164 that extends from the shaft 160 in a different direction or different angular or rotational direction from the shaft axis 170 may provide a larger gap between the barb 162 and the base 130 into which the mesh member may extend and thus make it easier for the barb 162 to engage or capture one or more filaments 52 and secure the cushion 50. In other words, such positioning may make it less likely that the rib 164 will block one or more filaments 52 from extending under and being captured by the barb 162.

In some configurations, the rib 164 is angled, curved, or tapered such that the rib 164 extends closer to the shaft 160 or shaft axis 170 as the distance from the base 130 increases. For instance, the rib 164 may comprise a rib end 180 (e.g., side, edge) that faces away from the shaft 160. The rib end 180 may be disposed closer to the shaft 160 or shaft axis 170 as the distance from the base 130 increases. The rib end 180 may be linear or nonlinear (e.g., curved, stepped, etc.). In the configuration shown in FIG. 6, the rib end 180 as a linear configuration in which the rib and becomes progressively closer or increasingly closer to the shaft axis 170 at a constant rate as the distance from the base 130 increases. Providing a rib end 180 that is angled, curved, or tapered may allow the rib 164 to act as a wedge the helps the fastener 132 penetrate the cushion 50 or penetrate between filaments 52 of the mesh member of the cushion 50 when the fastener 132 is inserted into the cushion 50.

In some configurations, the rib 164 extends from the base 130 along a portion of the length of the shaft 160. As such, the rib 164 may be spaced apart from and may not extend to the distal end 172 of the shaft 160. For instance, the rib 164 may extend to approximately the same distance or height from the base 130 as the distal end 176 of the barb 162, which may make it easier for the shaft 160 and barb 162 to penetrate between filaments and/or make it easier for a filament 52 to be captured by the barb 162.

Referring primarily to FIGS. 4 and 5, a plurality of fasteners 132 or set of fasteners 132 may be arranged on the base 130. For clarity, only some of the fasteners 132 are labeled in these figures. In these figures, the fasteners 132 are depicted as extending from the first base side 140 and are arranged such that the fasteners 132 or members of the set of fasteners 132 are spaced apart from each other.

In some configurations, the fasteners 132 may be oriented such that the barb 162 of one fastener 132 extends in a different direction with respect to the barb 162 of another fastener 132, such as different angles or rotational positions when viewed along the shaft axis 170. For instance, the barb 162 of a first fastener 132 may be “clocked” with respect to the barb 162 of a second fastener 132 such that the barb 162 of the first fastener 132 extends at a different angle or in a different rotational direction with respect to the barb 162 of the second fastener 132. Providing barbs 162 that extend in different directions may help the fastening arrangement 120, 120′ resist loads or forces that may be exerted on the cushion 50 in different directions, and thus better resist disengagement of the cushion 50 from the fastening arrangement 120, 120′.

An example of first and second fasteners with barbs extending in different directions is shown in FIG. 6. In FIG. 6, the shaft 160 and barb 162 of a first fastener 132, which may be referred to a first shaft and first barb, are disposed in the first plane 200. The shaft axis 170 and barb axis 174 of the first fastener 132 may be disposed in the first plane 200. The shaft 160 and barb 162 of the second fastener 132, which may be referred to as a second shaft and a second barb, are disposed in a second plane 202 that differs from the first plane 200. The shaft axis 170 and barb axis 174 of the second fastener 132 may be disposed in the second plane 202. In this example, the first plane 200 intersects the second plane 202, the first barb 162 extends away from the second plane 202 (e.g., the barb axis 174 of the first barb 162 is completely disposed in the first plane 200 but is not completely disposed in the second plane 202), and the second barb 162 extends away from the first plane 200 (e.g., the barb axis 174 of the second barb 162 is completely disposed in the second plane 202 but is not completely disposed in the first plane 200). Thus, in this example, the first plane 200 intersects the second plane 202 and may be disposed in a nonparallel relationship, which may or may not be a perpendicular relationship. It is also contemplated that the first plane 200 and second plane 202 may be disposed in a parallel relationship and may not intersect. In some configurations, the first plane 200 and the second plane 202 may be disposed substantially perpendicular to the base 130.

In some configurations, the fasteners 132 are arranged in a first grid 190 or grid pattern (e.g., network of lines that cross each other to form a series of quadrilaterals, such as squares or rectangles). The first grid 190 is represented by dotted lines in FIG. 5. For instance, the first grid 190 may comprises rows and columns. One or more rows may be disposed substantially perpendicular to one or more columns. A fastener 132 may be provided where a row and a column intersect.

In some configurations, the fasteners 132 are arranged such that the barb 162 of one fastener 132 extends in a first direction, such as along a row of the grid pattern, and the other barb 162 extends in a second direction that differs from the first direction. For instance, barbs 162 of one or more adjacent fasteners 132 may extend in different directions. Adjacent fasteners may be fasteners that are disposed closest to each other, such as fasteners 132 disposed in the same row or the same column.

An example of barbs 162 of adjacent fasteners 132 extending in different directions is shown in FIG. 7. In the example shown in FIG. 7, four fasteners 132 are illustrated that have barbs 162 that extend in different directions with respect to each other. The leftmost fastener 132 in FIG. 7 has a barb 162 that extends to the right from the perspective shown. The second fastener 132 from the left extends away from the viewer from the perspective shown in FIG. 7. The third fastener from the left has a barb 162 that extends to the left from the perspective shown. The fourth fastener from the left or rightmost fastener 132 has a barb 162 that extends toward the viewer from the perspective shown. Thus, in this example, the barbs 162 are “clocked” by 90 degrees with respect to each other and extend in different angular directions with respect to the shaft 160 or shaft axis 170. Thus, one barb 162 may be disposed along a row of the first grid 190 while an adjacent barb 162 may extend along a column of the first grid 190. It is contemplated that barbs 162 may be oriented at relative angular positions other than 90 degrees and that one or more barbs 162 may extend in the same direction. For instance, in some configurations one or more barbs 162, such as one or more barbs in a row or column may extend in the same direction with respect to the shaft 160 or shaft axis 170.

In the configuration shown in FIGS. 8-12, the fastening arrangement 120′ includes fasteners 132 that extend from different sides of the base 130. For instance, the fastening arrangement 120′ may include one or more fasteners 132 or a second set of fasteners 132 that extend from the second base side 142 in addition to one or more fasteners 132 or a first set of fasteners 132 that extend from the first base side 140.

Referring to FIG. 12, a fastener 132 that extends from the second base side 142 extends into a second cushion 50′. The second cushion 50′ may comprise a second mesh member or filament mesh structure as previously discussed. As such, the fastening arrangement 120′ is configured to secure the cushion 50 to the second cushion 50′. The second cushion 50′ is disposed on and may contact or engage the second base side 142. The fasteners 132 that extend from the second base side 142 may be oriented such that the barb 162 of a first fastener 132 that extends from the second base side 142 extends in a different direction with respect to the barb 162 of a second fastener 132 that extends from the second base side 142, such as different angles or rotational positions when viewed along the shaft axis 170 as previously discussed with respect to fasteners that extend from the first base side 140.

In some configurations, one or more fasteners 132 that extend from the first base side 140 may not be disposed directly opposite a fastener 132 that extends from the second base side 142. An example of such a configuration is best shown in FIGS. 9-12. Thus, a first fastener 132 that extends from the first base side 140 may not be disposed directly opposite a second fastener 132, which may also be referred to as a secondary fastener, that extends from the second base side 142. Arranging fasteners in this manner may facilitate manufacturing and may help distribute load forces across the base 130 so that load forces are less concentrated.

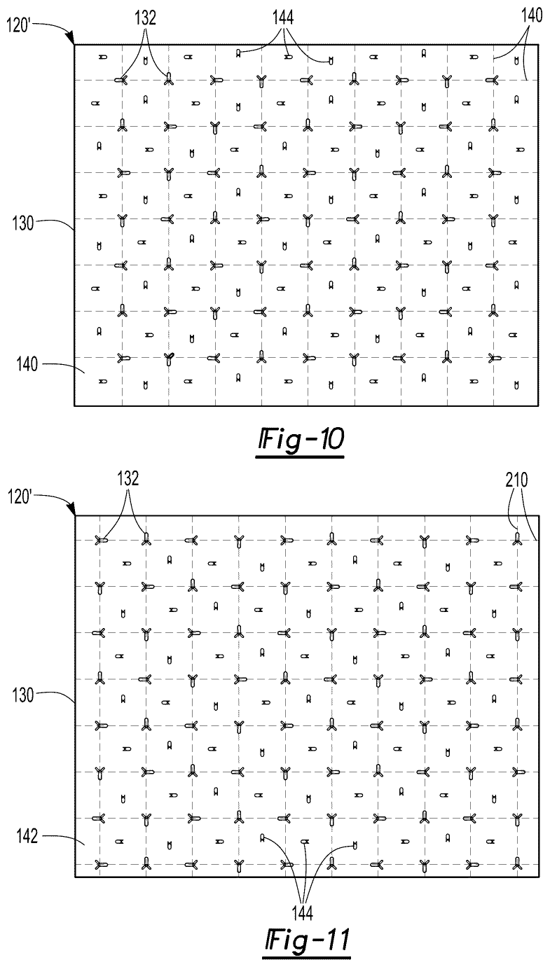

In some configurations, fasteners 132 that extend from the first base side 140 may be arranged in a first grid 190 as previously discussed and as is best shown in FIG. 10. Fasteners 132 that extend from the second base side 142 may be arranged in a second grid 210 or grid pattern (e.g., network of lines that cross each other to form a series of quadrilaterals, such as squares or rectangles), which is represented by dotted lines in FIG. 11. For instance, the second grid 210 may comprises rows and columns. One or more rows may be disposed substantially perpendicular to one or more columns. A fastener 132 may be provided where a row and a column intersect. In some configurations, the first grid 190 may be offset from the second grid 210, which is best shown by comparing FIGS. 10 and 11.
Clause 1. A seat assembly comprising: a cushion comprising a mesh member, the mesh member comprising a set of filaments of polymeric material, wherein at least two members of the set of filaments are looped and bonded to each other; and a fastening arrangement comprising a base upon which the cushion is disposed and a fastener extending from the base into the mesh member, wherein the fastener engages at least one member of the set of filaments, coupling the fastening arrangement to the cushion.
Clause 2. The seat assembly of clause 1 further comprising a trim cover disposed on the cushion, wherein the trim cover is detached from the fastening arrangement.
Clause 3. The seat assembly of any preceding clause wherein the base is disposed on a frame of the seat assembly.
Clause 4. The seat assembly of any preceding clause wherein the cushion comprises a first side and a second side opposite the first side, wherein the first side is disposed on the base and the fastener extends into the cushion from the first side toward the second side.
Clause 5. The seat assembly of any preceding clause wherein the base comprises a first base side that faces toward the cushion, and the fastener comprises a shaft extending from the first base side and a barb extending from the shaft toward the first base side.
Clause 6. The seat assembly of clause 5 wherein the fastening arrangement further comprises a second fastener, the second fastener comprising a second shaft extending from the first base side and a second barb extending from the second shaft toward the first base side, wherein the shaft and the barb of the fastener are in a first plane and the second shaft and the second barb of the second fastener are in a second plane.
Clause 7. The seat assembly of clause 6 wherein the first plane intersects the second plane and the second shaft.
Clause 8. The seat assembly of clause 6 or clause 7 wherein the fastener and the second fastener are members of a set of fasteners arranged on the base in a first grid.
Clause 9. The seat assembly of any preceding clause wherein the base further comprises a set of openings arranged in the base.
Clause 10. The seat assembly of any of clauses 5 to 9 when dependent on claim 5 further comprising a secondary fastener extending from a second base side.
Clause 11. The seat assembly of clause 10 wherein the second base side is opposite the first base side and the secondary fastener extends into a second cushion, the second cushion comprising a second mesh member, the second mesh member comprising a set of filaments of polymeric material, wherein at least two members of the set of filaments of the second mesh member are looped and bonded to each other.
Clause 12. The seat assembly of clause 11 wherein the second cushion is disposed on the second base side.
Clause 13. The seat assembly of any of clauses 10 to 12 wherein the fastener and the secondary fastener are offset from each other such that the fastener is not disposed directly opposite the secondary fastener.
Clause 14. The seat assembly of any of clauses 10 to 13 wherein the fastener is a member of a first set of fasteners arranged in a first grid on the first base side.
Clause 15. The seat assembly of any of clauses 10 to 14 wherein the secondary fastener is a member of a second set of fasteners arranged in a second grid on the second base side.
Clause 16. A fastening arrangement comprising: a base; and a fastener comprising: a shaft extending from the base along a shaft axis; a barb extending from the shaft toward the base; and a rib extending from the base to the shaft, wherein the barb and the rib extend away from the shaft axis in different directions.
Clause 17. The fastening arrangement of clause 16 wherein the barb extends along a barb axis from a distal end of the shaft and is separated from the base.
Clause 18. The fastening arrangement of clause 16 or clause 17 wherein the rib comprises a rib end that faces away from the shaft and the rib end is disposed closer to the shaft axis as a distance from the base increases.
Clause 19. The fastening arrangement of any of clauses 16 to 18 further comprising a second fastener that extends from an opposite side of the base from the fastener, wherein the fastener and the second fastener are not disposed directly opposite each other.
Clause 20. The seat fastening arrangement of any of clauses 16 to 19 wherein the base further comprises a through hole disposed adjacent to the shaft and aligned with the barb.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A seat assembly comprising:
a cushion comprising a mesh member, the mesh member comprising a set of filaments of polymeric material, wherein at least two members of the set of filaments are looped and bonded to each other; and
a fastening arrangement comprising a base upon which the cushion is disposed and a fastener extending from the base into the mesh member, wherein the fastener engages at least one member of the set of filaments, coupling the fastening arrangement to the cushion.

2. The seat assembly of claim 1 further comprising a trim cover disposed on the cushion, wherein the trim cover is detached from the fastening arrangement.

3. The seat assembly of claim 1 wherein the base is disposed on a frame of the seat assembly.

4. The seat assembly of claim 1 wherein the cushion comprises a first side and a second side opposite the first side, wherein the first side is disposed on the base and the fastener extends into the cushion from the first side toward the second side.

5. The seat assembly of claim 1 wherein the base comprises a first base side that faces toward the cushion, and
the fastener comprises a shaft extending from the first base side and a barb extending from the shaft toward the first base side.

6. The seat assembly of claim 5 wherein the fastening arrangement further comprises a second fastener, the second fastener comprising a second shaft extending from the first base side and a second barb extending from the second shaft toward the first base side, wherein the shaft and the barb of the fastener are in a first plane and the second shaft and the second barb of the second fastener are in a second plane.

7. The seat assembly of claim 6 wherein the first plane intersects the second plane and the second shaft.

8. The seat assembly of claim 6 wherein the fastener and the second fastener are members of a set of fasteners arranged on the base in a first grid.

9. The seat assembly of claim 8 wherein the base further comprises a set of openings arranged in the base.

10. The seat assembly of claim 5 further comprising a second fastener extending from a second base side.

11. The seat assembly of claim 10 wherein the second base side is opposite the first base side and the second fastener extends into a second cushion, the second cushion comprising a second mesh member, the second mesh member comprising a set of filaments of polymeric material, wherein at least two members of the set of filaments of the second mesh member are looped and bonded to each other.

12. The seat assembly of claim 11 wherein the second cushion is disposed on the second base side.

13. The seat assembly of claim 10 wherein the fastener and the second fastener are offset from each other such that the fastener is not disposed directly opposite the second fastener.

14. The seat assembly of claim 10 wherein the fastener is a member of a first set of fasteners arranged in a first grid on the first base side.

15. The seat assembly of claim 14 wherein the second fastener is a member of a second set of fasteners arranged in a second grid on the second base side.

16. A fastening arrangement comprising:
a base; and
a fastener comprising:
a shaft extending from the base along a shaft axis;
a barb extending from the shaft toward the base; and
a rib extending from the base to the shaft, wherein the barb and the rib extend away from the shaft axis in different directions.

17. The fastening arrangement of claim 16 wherein the barb extends along a barb axis from a distal end of the shaft and is separated from the base.

18. The fastening arrangement of claim 16 wherein the rib comprises a rib end that faces away from the shaft and the rib end is disposed closer to the shaft axis as a distance from the base increases.

19. The fastening arrangement of claim 16 further comprising a second fastener that extends from an opposite side of the base from the fastener, wherein the fastener and the second fastener are not disposed directly opposite each other.

20. The fastening arrangement of claim 16 wherein the base further comprises a through hole disposed adjacent to the shaft and aligned with the barb.
